(19) United States
(12) Patent Application Publication
(10) Pub. No.: US 2011/0320431 A1
(43) Pub. Date: Dec. 29, 2011

(54) STRONG TYPING FOR QUERYING INFORMATION GRAPHS

(75) Inventors: Thomas E. Jackson, Redmond, WA (US); Stuart M. Bowers, Redmond, WA (US); Brian S. Aust, Redmond, WA (US); Chris D. Karkanias, Sammamish, WA (US); Allen L. Brown, JR., Bellevue, WA (US); David G. Campbell, Sammamish, WA (US)

(73) Assignee: MICROSOFT CORPORATION, Redmond, WA (US)

(21) Appl. No.: 12/823,132

(22) Filed: Jun. 25, 2010

(51) Int. Cl. G06F 17/30

(52) U.S. Cl. 707/713; 707/769; 707/E17.017; 707/798; 707/E17.011

(57) ABSTRACT

Described herein is using type information with a graph of nodes and predicates, in which the type information may be used to determine validity of (type check) a query to be executed against the graph. In one aspect, each node has a type, and each predicate indicates a valid relationship between two types of nodes. A type checking mechanism uses the type information to determine whether a query is valid, which may be the entire query prior to query processing/compilation time, or as the query is being composed by a user. One or more valid predicates for a given node may be discovered based upon the node type, such as discovered to assist the user during query composition. Also described is using the type information to optimize the query.

### BACKGROUND

When querying information in a graph-based manner (such as with a SPARQL or Prolog query), relatively complex queries are sometimes needed. These can be difficult to compose, sometimes resulting in invalid queries being executed by the reasoning engine.

An invalid query is one that is sent to a reasoning engine for execution, but may produce no result set, which leads to excessive utilization of the resources of the reasoning engine as it attempts to find results. An invalid query that is executed also may produce results because of ambiguity in the underlying data, or produce misleading results because of a coincidence. For example, consider a query directed towards a person's surname, which is also part of the name of a company. A query may produce results because a company with a surname erroneously exists in the data, or because a company that happens to have the same identifier as a person coincidentally exists.

In general, in querying graph-based information, there is little to no support for checking whether a query is well-formed. Moreover, even well-formed queries can benefit from additional knowledge about the information being queried.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a graph of nodes that represent entities and predicates that represent connections between some of the entities are each associated with type information. For nodes, the type information indicates the type of the node, and for predicates the (other) type information comprises data that indicates a valid relationship between two node types. A type checking mechanism uses the type information to determine whether a query is valid, which may be applied to the entire query as a part of query processing (e.g., compilation) or performed on a partial query as the query is being composed by the author, that is, before composition is complete.

In one aspect, given a node, one or more valid predicates for that node may be discovered based upon the node type. The valid predicates may be presented for user selection, e.g., during query composition to assist the user.

In one aspect, the type information may be used to optimize the query. In general, this is because the nodes and relationships that need to be accessed to execute the query are known as a result of the type checking.

In one aspect, query specifications contain specifications of the form of one or more (subject, predicate, object) triples identified in the query. The type information for the subject node, the type information for the object node, and the type data for the predicate are accessed to determine whether the type information of the subject and the type information of the object indicate that the nodes are validly related to one another.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of a graph showing various relationships between various entities that may be extended with type information as described herein.

FIG. 2 is a block diagram representing a system that uses type information to type check a query prior to execution.

FIG. 3 is a representation of a graph showing how nodes may be associated with type information to facilitate type checking.

FIG. 4 is a representation of data in a graph showing how type information for a node may be used to determine which predicates exist that describe valid relationships with other nodes.

FIG. 5 is a representation of data in a graph showing how type information for nodes and predicates may be used to determine whether a query is valid or invalid.

FIG. 6 shows an illustrative example of a computing environment into which various aspects of the present invention may be incorporated.

### DETAILED DESCRIPTION

Various aspects of the technology described herein are generally directed towards a system that checks whether queries are valid (well-formed), based upon type information in an information graph. Because of the type information, invalid queries can be detected before execution, and as described below, well-formed queries may be executed more quickly.

To this end, facts in a graph-based system are represented as labeled, directed connections between nodes representing entities. Unlike other such systems, each node in the graph instantiates a single type, and each labeled edge (“Predicate”) is associated with two nodes, each of a particular type. As a result, the system can determine whether a query is correct by verifying that the types of the predicates and entities involved in the graph pattern of the query are compatible with one another.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and data processing in general.

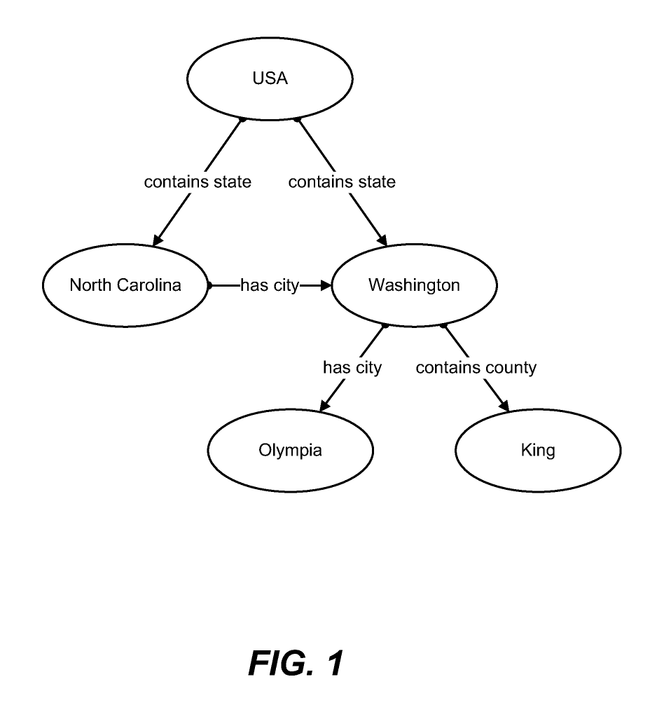

In one implementation, the system implements a graph-based model for representing information. Graph-based models present facts in the form of subject-predicate-object statements. By way of example, a graph based information system represents the fact that the capital of Washington State is the city of Olympia as a simplified statement such as shown below and with reference to FIG. 1:
<Washington><has city><Olympia>

Note that without type information, the graph based system shown in FIG. 1 has an ambiguity, namely that “Washington” may be a city in North Carolina or may be a state in the United States. An otherwise valid query may return misleading information in this situation. By way of example, under certain circumstances a user may select the city of Washington, then ask if that city has a capital (not meaningful), and discover, incorrectly, that the city has Olympia as its capital. In a strongly typed system the user is not allowed to ask the second part of the query, because the predicate has the wrong type

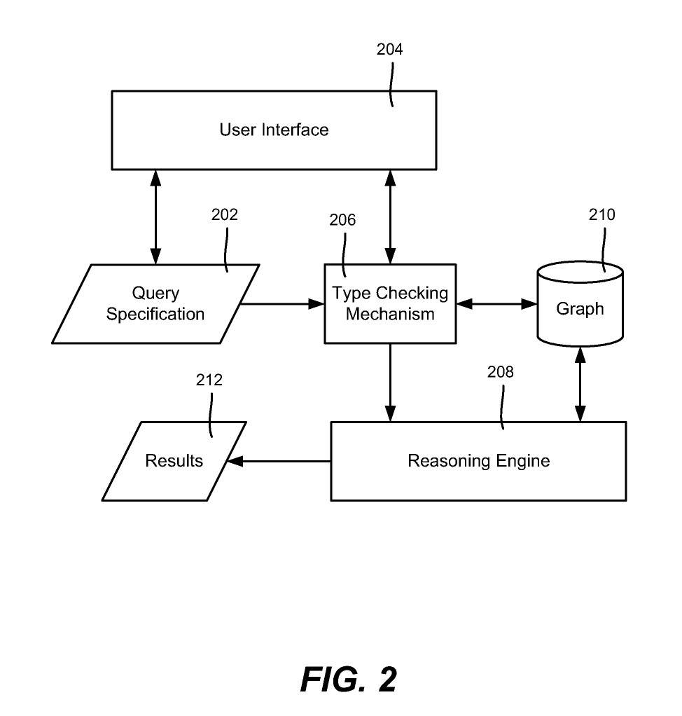

FIG. 2 is a block diagram showing an example system for including type checking in querying graph-based models. In general, a query specification 202 directed towards execution is composed via an appropriate user interface 204, and type checked by a type checking mechanism 206 (e.g., a programming interface) before being executed. Note that the type checking mechanism 206 may be coupled to (or incorporated into) the user interface 204 to assist in composing well-formed queries during composition of the query, as well as built into or accessed by a compiler that processes the query for execution.

In this manner, only well-formed queries as determined by the type checking mechanism 206 are provided to the reasoning engine 208 for querying the graph 210. The returned results 212 are thus not misleading.

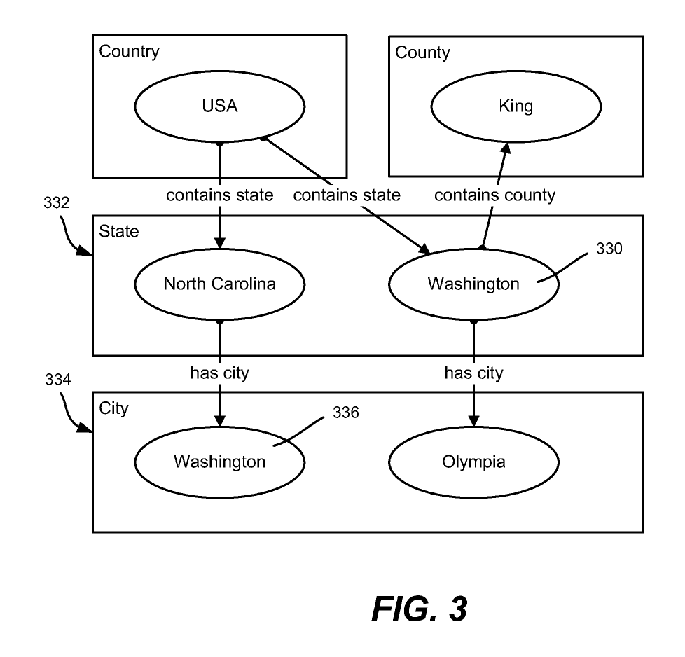

In order to apply typing to a graph model, graph data for each entity (node) is associated with a type when it is entered into the system; each predicate (edge) is associated with two entities, and specifies a type for each adjacent entity. For example, as generally represented in FIG. 3, the nodes representing subject entities and object entities have associated type data, as do the edges (predicates) that represent the relationships between the subjects and objects.

The association is made when adding information to the graph. For example, when entering graph data, it is known that cities have valid relationships to states, but cities do not have valid relationships with a spouse's first name, for example.

The type association may be made in any desired way in a given implementation. For example, if a data structure (e.g., object) represents a type, each node of that type may be an instance of that type, with predicates defined to relate types to certain other types. Thus, there may be a location in the database containing a ‘city’ table, another for a ‘state’ table, and so on. This provides advantages because it is more difficult to incorrectly type an entry, e.g., putting data in the table makes that data of that type. Alternatives are feasible, e.g., a table may contain all of the nodes in its rows, with a column that indicates the type for that row/node, however this is somewhat more susceptible to erroneous entry of a node's type information.

As a result of extending the system to include type information (shown below as <value:type>), the above example may be represented as below and as in FIG. 3):
<Washington:State><has city:State˜City><Olympia:City>

Note in particular that the node 330 for <Washington> includes its type, State 332, through a suitable association. Note that while there are two nodes 330 and 336 for ‘Washington’ there is only one node of type state 332. Thus, with the type information, the node 330 that represents ‘Washington’ cannot ambiguously refer to either the state of Washington, USA or the city of Washington, N.C.

Further note that the predicate <has city> is identified to connect nodes of type State on the left and nodes of type City 334 on the right. This indicates a valid relationship between a node associated with a state type 332 node and a node associated with a city type 334. Queries that do not make sense with respect to the given graph 210 are thus detected.

Each set of subject-predicate-object statements is thus accessed through the type checking mechanism 206. In one implementation of the system, the type checking mechanism 206 may maintain the type information for each node and each predicate, and thereby produce (or verify) fully typed edges, and detect any that are not fully typed. Note by applying type checking at the type checking mechanism 206 (graph interface), the sets of edges for each predicate can be stored separately, allowing for fast access and querying of these sets of facts.

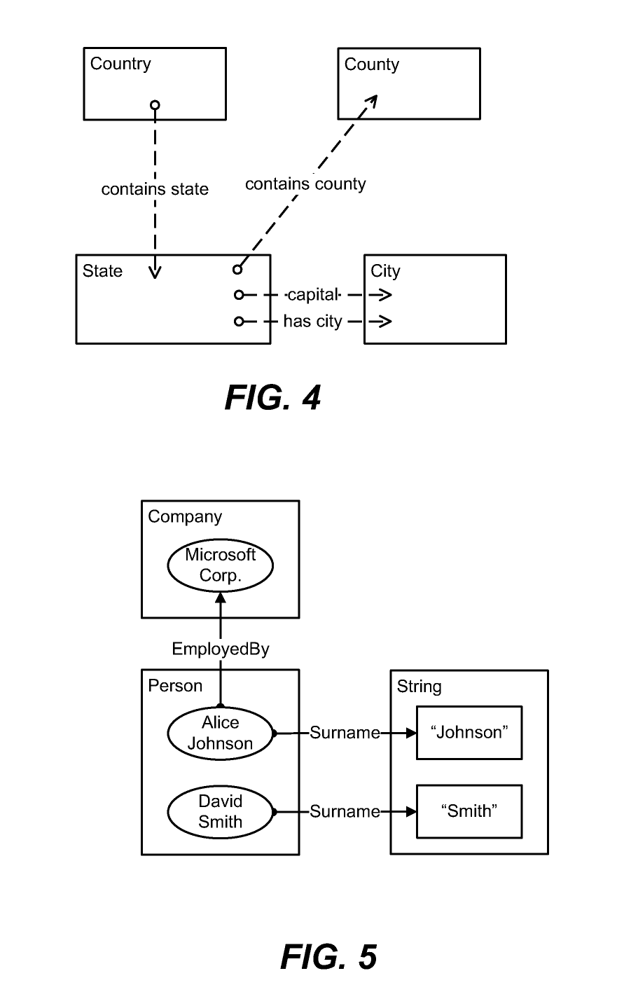

The system provides a type system that allows predicates to be queried based on their name or the types of the nodes they connect. By way of example, the system is able to answer questions such as “which predicates are able to validly connect to <Washington:State>?”. Such a query produces a set of valid predicates that may connect to the node in question, as generally represented in FIG. 4:

```
    <has city:State~City>
    <capital:State~City>
<contains state:Country~State>
<contains county:State~County>
```

With this information, queries may be executed to determine what facts have been stored about the state of Washington. Such queries fully exclude predicates such as <produced by:Product˜Company> for example, because <Washington:State> is neither of type Product nor Company.

As can be readily appreciated, this aspect may assist a user in formulating a query. For example, in the user interface 204, a user that identifies <Washington:State> as a node may be given a drop down menu of valid predicates from which to select, e.g., to query for a list of the counties in Washington state. While this may seem straightforward for city, county, state and country relationships, a more elaborate graph such as one that represents drug interactions or gene sequences may have defined relationships presented in this way. Presenting a user with a (more limited number) of only valid choices means that the user does not have to guess at whether a relationship is valid.

Further, the system can find connections faster by only following predicates where the type matches. In other words, once type checked, static optimization of queries based on type information is provided. The static type checking of the predicates listed in a query specification allows the system to include in its query execution only those types associated with those predicates. This allows pre-selecting a set of candidate edges, such a searching an entire database is not needed. If each edge corresponds to its own dedicated storage, such access may be highly efficient.

Alternatively, the types may be requested from the system for a collection of predicates. By way of example, consider the SPARQL Queries below with reference to the graph in FIG. 5:

| SELECT ?person ?company ?name | | |
|---|---|---|
| WHERE { | | |
| ?person | <EmployedBy> | ?company. |
| ?person | <Surname> | ?name. |
| } | | |
| SELECT ?person ?company ?name | | |
| WHERE { | | |
| ?person | <EmployedBy> | ?company. |
| ?company | <Surname> | ?name. |
| } | | |

Note that both of the above queries constitute semantically valid SPARQL queries (and can be directly translated to Prolog or Datalog). However, because surnames are only associated with people, and not companies, the second query is logically invalid because it attempts to bind the same variable, ?company, to both an <EmployedBy> edge and a <Surname> edge. Mistakes such as these often occur with a graph query language. However, the system described herein detects such errors by type checking queries.

More particularly, when the above queries are compiled, the types of the predicates involved in this query are retrieved. In the above example, two predicates are involved, as generally represented below and in FIG. 5:

<EmployedBy:Person~Company>
<Surname:Person~String>

The system uses this information when unifying variable references. For both queries, the results of the query amount to finding values for ?person, ?company, and ?name such that edges exist for each line of the graph pattern. In order for such a result to exist, all variables need to be determined to be of a single type:
Query 1: ?person is of type Person, ?company is of type Company, and ?name is of type String, so this query may execute.
Query 2: ?person is of type Person, and ?name is of type String, but ?company needs to be either Person or Company. Since it cannot be both, this query is invalid.

Note that the second query does not make sense, because it is asking for a company's surname, however (in any sensible graph) companies do not have surnames, only people do, which the type system detects. Notwithstanding, in other systems, the invalid query is executed, with the three possible (undesirable) outcomes set forth above, namely the query produces no result set (the system is taxed to try to find a particular Company that also has connections like a Person, but fails as none exist); the query produces results because there erroneously exists a company with a surname, (which indicates an error in the original data), or the query produces results because there exists a company that happens to have the same identifier as a person, (a coincidence that may be misleading to the user).

In these examples, the system and user benefit from the early detection of such semantic errors. The detection may be performed in the user interface as the user composes the query, and/or in the reasoning engine before execution if not previously detected.

### Exemplary Operating Environment

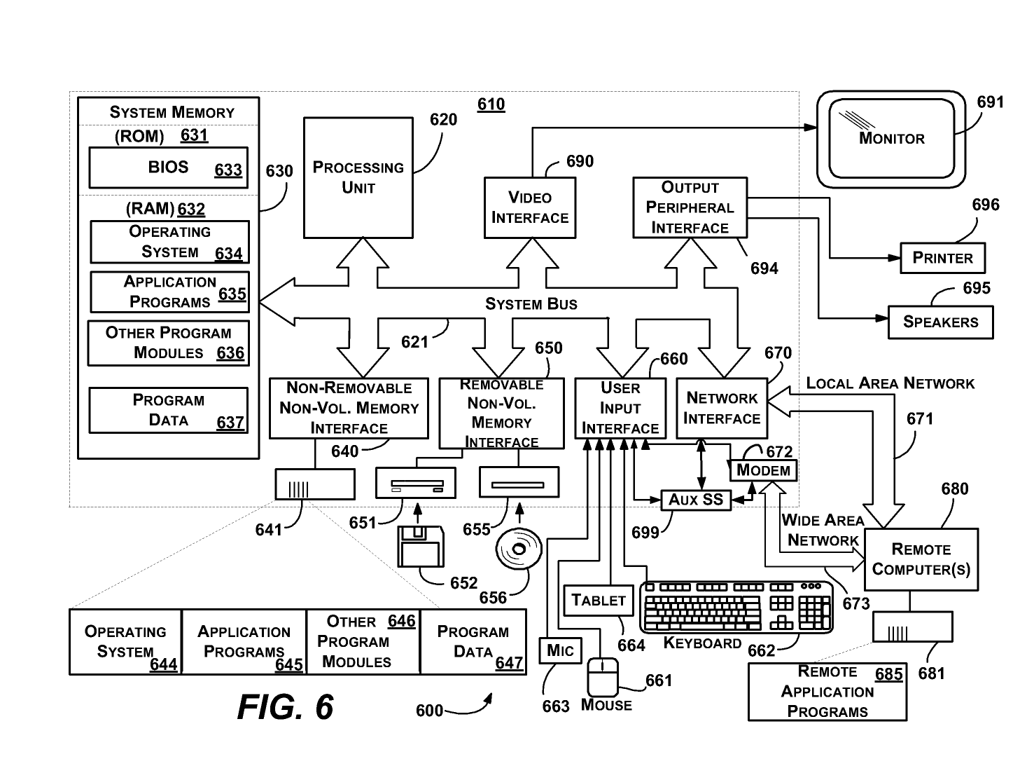

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising, accessing type information associated with a graph, and using the type information to determine whether at least part of a query is valid with respect to querying the graph.

2. The method of claim 1 wherein accessing the type information associated with the graph comprises obtaining type information for an object node and type information for a subject node, and determining whether a subject node has a valid relationship with an object node.

3. The method of claim 2 wherein accessing the type information associated with the graph comprises accessing a predicate set containing at least one predicate that each includes connection data representing valid connections between node types, and wherein determining whether the subject node has a valid relationship with the object node comprises evaluating the connection data.

4. The method of claim 1 wherein accessing the type information comprises receiving a composed query directed towards a reasoning engine.

5. The method of claim 1 wherein accessing the type information comprises receiving query-related data at a user interface during composition of the query.

6. The method of claim 5 wherein the type information corresponds to a node type, and further comprising, discovering one or more valid predicates based upon the node type.

7. The method of claim 6 further comprising, presenting the one or more valid predicates via the user interface, for selection of a valid predicate.

8. The method of claim 1 further comprising, using the type information to optimize the query.

9. In a computing environment, a system comprising, data corresponding to a graph of nodes that represent entities and predicates that represent connections between some of the entities, each node associated with type information that indicates a type of the node, and each predicate associated with other type information that indicates a valid relationship between one type of node and another type of node, and a type checking mechanism that uses the type information and other type information to determine whether at least part of a query is valid.

10. The system of claim 9 further comprising a user interface by which the query is entered, the user interface coupled to the type checking mechanism to check whether at least part of a query is valid.

11. The system of claim 9 wherein the type checking mechanism provides a set of one or more predicates that are able to be validly connected to a node.

12. The system of claim 11 further comprising a user interface that presents the set of one or more predicates for user selection of a valid predicate.

13. The system of claim 9 further comprising means for optimizing the query based at least in part on the type information of the nodes and the type information of the predicates.

14. The system of claim 9 wherein the type checking mechanism uses the type information and other type information to determine whether at least part of a query is valid at a compile time prior to executing the query.

15. The system of claim 9 wherein each node is associated with the type information by being maintained in a data structure corresponding to the type information.

16. The system of claim 9 wherein the query identifies a subject node, predicate and object node, in which the query requests results corresponding to of one or more object nodes that have an identified relationship with the subject node and the type checking mechanism determines whether the type of the subject node has a valid relationship with the type of the object node.

17. The system of claim 9 wherein the query identifies a subject node, predicate and object node, in which the query requests results corresponding to of one or more subject nodes that have an identified relationship with the object node and the type checking mechanism determines whether the type of the object node has a valid relationship with the type of the subject node.

18. One or more computer-readable media having computer-executable instructions, which when executed perform steps, comprising:
maintaining type information for a graph of nodes and predicates, including maintaining type information for each node, and maintaining type data for each predicate that identifies a valid relationship between types of nodes; and
type checking a query, including for each subject, predicate, object triple identified in the query, accessing the type information for the subject node, the type information for the object node, and the type data for the predicate to determine whether the type information of the subject and the type information of the object indicates that the nodes are validly related to one another.

19. The one or more computer-readable media of claim 18 having further-executable instructions comprising, determining that the query is valid with respect to type checking, optimizing the query based at least in part of the type data for at least one predicate, and executing the query after optimization to return results.

20. The one or more computer-readable media of claim 18 wherein type checking the query includes receiving a subject, predicate, object triple during composition of the query, and performing type checking before composition of the query is complete.
